(19) United States
(12) Patent Application Publication
(10) Pub. No.: US 2013/0240107 A1
(43) Pub. Date: Sep. 19, 2013

(54) Pneumatic Tire

(71) Applicant: Masahiro Ebiko, Hiratsuka-shi (JP)

(72) Inventor: Masahiro Ebiko, Hiratsuka-shi (JP)

(73) Assignee: THE YOKOHAMA RUBBER CO., LTD., Tokyo (JP)

(21) Appl. No.: 13/885,997

(22) PCT Filed: Sep. 5, 2011
(86) PCT No.: PCT/JP2011/070103

§ 371 Date: May 16, 2013

(30) Foreign Application Priority Data
Nov. 17, 2010 (JP) 2010-257182

(51) Int. Cl. B60C 15/00; B60C 15/06

(52) U.S. Cl. CPC B60C 15/0009; B60C 15/0603
USPC 152/541

(57) ABSTRACT

A pneumatic tire is proposed in which reduction in weight and steering stability of the tire are both achieved to a high degree. A height of a bead filler from a bead heel is from 10 to 30 mm, an inner liner layer disposed inward of a carcass layer is formed from a thermoplastic resin or a thermoplastic elastomer composition that is blended from a thermoplastic resin component and an elastomer component having a Young's modulus of from 70 to 1500 MPa and a thickness of from 0.05 to 0.25 mm, and an end of the inner liner layer is disposed farther inward in a tire radial direction than an end outward in the tire radial direction of the bead filler.

### TECHNICAL FIELD

The present invention relates to a pneumatic tire, and more particularly relates to a pneumatic tire in which reduction in weight and steering stability of the tire are both achieved to a high degree.

### BACKGROUND

In recent years, reduction in weight of tires has been demanded with the object of fuel efficiency of vehicles. The methods of reduction in weight have included reduction in a thickness of a rubber layer that constitutes the tire, and reduction in the number of carcass layers. However, when these measures are adopted, the rigidity of the tire in a circumferential direction is greatly reduced, and this had the problem that the steering stability was reduced.

Japanese Unexamined Patent Application Publication No. 2009-001228 proposes a tire in which both end portions of the carcass layer are folded back to a position that exceeds a tire maximum width, a height of a bead filler from a bead heel is from 15 to 30% of a tire cross-sectional height, a rubber thickness of a side wall portion is from 3.5 to 5.0 mm, an inner liner is formed from a thermoplastic resin or a thermoplastic elastomer composition having a Young's modulus of from 5 to 50 MPa and a thickness of from 0.05 to 0.25 mm, to achieve both reduction in weight and steering stability of the tire. However, even with a tire of this configuration, the improvement effect of reduction in weight and steering stability of the tire was not necessarily sufficient, and further improvements are required.

### SUMMARY

The present technology provides a pneumatic tire in which reduction in weight and steering stability of the tire are both achieved to a high degree. The pneumatic tire according to the present technology is a pneumatic tire comprising a carcass layer mounted between a pair of bead portions, the carcass layer being folded back around a bead core embedded in each of the bead portions, a bead filler disposed on the bead core, and an inner liner layer disposed inward of the carcass layer. In such a pneumatic tire, a height H of the bead filler from a bead heel is from 10 to 30 mm, the inner liner layer is formed from a thermoplastic resin or a thermoplastic elastomer composition that is blended from a thermoplastic resin component and an elastomer component having a Young's modulus of from 70 to 1500 MPa and a thickness of from 0.05 to 0.25 mm, and an end of the inner liner layer is disposed farther inward in a tire radial direction than an end outward in the tire radial direction of the bead filler.

In the present technology, the height H of the bead filler from the bead heel is from 10 to 30 mm, so the tire weight is reduced. Also, the inner liner layer disposed inward of the carcass layer is formed from a thermoplastic resin or a thermoplastic elastomer composition that is blended from a thermoplastic resin component and an elastomer component having a Young's modulus of from 70 to 1500 MPa and a thickness of from 0.05 to 0.25 mm. Therefore, in addition to reducing the weight of the tire, the steering stability is enhanced, so it is possible to achieve both reduction in weight and steering stability to a high degree. In addition, an end of the inner liner layer is disposed farther inward in the tire radial direction than the end outward in the tire radial direction of the bead filler so that the inner liner layer and the bead filler are overlapped, so the variation in rigidity at the end outward in the tire radial direction of the bead filler is mitigated, so the steering stability can be enhanced.

In the present technology, preferably, the carcass layer has a single-layer structure, and a turned-up edge of the carcass layer is disposed farther inward in the tire radial direction than a maximum tire width position and farther outward in the tire radial direction than the end outward in the tire radial direction of the bead filler. As a result, it is possible to achieve both reduction in weight and steering stability to an even higher degree. In particular, preferably, the turned-up edge of the carcass layer is separated from the maximum tire width position by not less than 10 mm inward in the tire radial direction, and separated from the end outward in the tire radial direction of the bead filler by not less than 10 mm outward in the tire radial direction.

In the present technology, preferably, the cross-sectional area in a meridian cross-section of the bead filler is from 20 to 90 mm², and the shape of the bead filler tapers to a point at the end outward in the tire radial direction. As a result, it is possible to further reduce the weight of the tire.

In the present technology, preferably, the end of the inner liner layer is disposed at a position separated from the end outward in the tire radial direction of the bead filler by from 5 to 20 mm inward in the tire radial direction. As a result, the tire durability is improved, and it is possible to suppress the occurrence of appearance flaws that occur during vulcanization.

In the present technology, preferably, an average rubber thickness of a side rubber layer constituting a side wall portion is from 2.0 to 3.5 mm. In this way, it is possible to reduce the weight of the tire while maintaining the side cut properties of the tire.

In the present technology, preferably, the bead core has a single wire bead core structure in which a single bead wire is wound around the bead core a plurality of times in an annular shape, and a spacing between the loops of the bead wires in a meridian cross-section of the bead core is not more than 0.3 mm. As a result, it is possible to increase the bending rigidity of the bead portion and enhance the steering stability.

In the present technology, preferably, a reinforcing layer formed from a composite material of steel cords or organic fiber cords and rubber is provided outward in the tire width direction of the bead filler and inward in the tire width direction of the carcass layer. As a result, the steering stability can be further enhanced.

In the present technology, preferably, tan δ at 60° C. of the rubber portion that includes the maximum tire width position of the side rubber layer that forms the side wall portion is in the range from 0.02 to 0.10. In this way, it is possible to suppress heat build-up in the side wall portion, and improve the rolling resistance.

In the present technology, preferably, a relationship between the tire cross-sectional width SW and the tire maximum belt width BW is such that 0.68≦BW/SW≦0.80. As a result, the steering stability can be further enhanced.

### BRIEF DESCRIPTION OF THE DRAWINGS

FIG. 1 is a meridian cross-sectional view illustrating a pneumatic tire according to an embodiment of the present technology.

FIG. 2 is a meridian cross-sectional view illustrating a pneumatic tire according to other embodiments of the present technology.

FIG. 3 is an explanatory view illustrating a method of measurement of an average rubber thickness of a side wall portion.

FIG. 4 is a cross-sectional view illustrating an enlargement of a portion of the side wall portion of the pneumatic tire according to the present technology.

### DETAILED DESCRIPTION

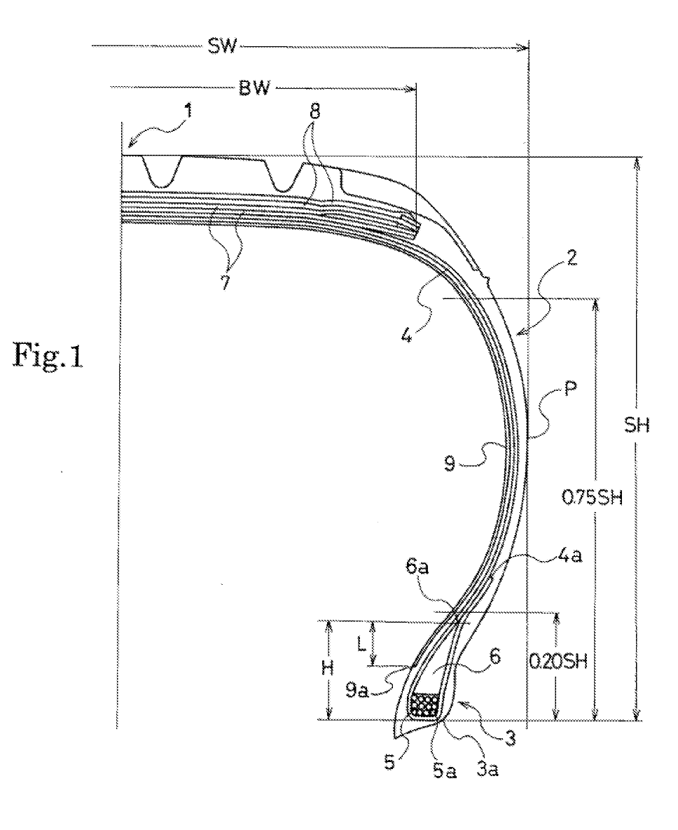

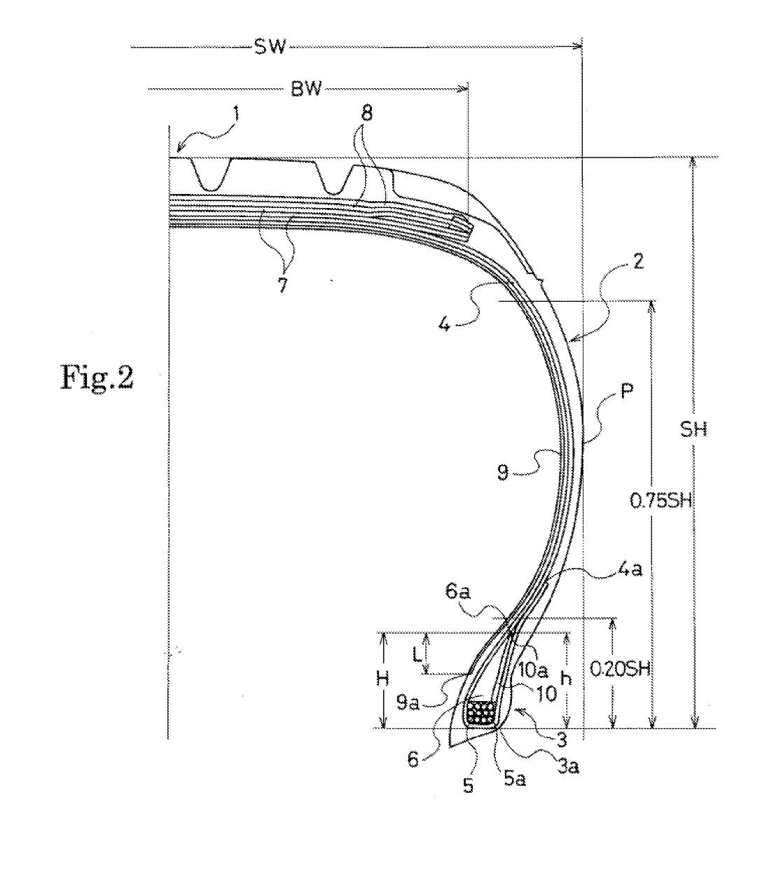

Detailed descriptions will be given below of a configuration of the present technology with reference to the accompanying drawings. FIGS. 1 and 2 illustrate a pneumatic tire according to an embodiment of the present technology.

In FIGS. 1 and 2, 1 is a tread portion; 2 is a side wall portion; and 3 is a bead portion. A carcass layer 4 is mounted between the left-right pair of bead portions 3, 3. The carcass layer 4 includes a plurality of reinforcing cords extending in a tire radial direction, and is folded back around a bead core 5 disposed in each of the bead portions 3 from the tire inner side to the tire outer side. Additionally, a bead filler 6 is disposed on a periphery of the bead core 5, and the bead filler 6 is enveloped by a main body part and a folded over part of the carcass layer 4.

On the other hand, two layers of a belt layer 7 formed from steel cords are disposed on an outer circumferential side of the carcass layer 4 in the tread portion 1 so that the cords intersect each other between layers. In addition, a belt reinforcing layer 8 with an organic fiber cord spirally wound thereon in the tire circumferential direction is provided on the outer circumferential side of the belt layer 7. Also, an inner liner layer 9 is disposed on an inner circumferential side of the carcass layer 4.

In an embodiment of FIG. 2, in addition to the configuration described above, a reinforcing layer 10 formed from a composite material of rubber and steel cords or organic fiber cords is provided outward in the tire width direction of the bead filler 6 and inward in the tire width direction of the carcass layer 4.

In the pneumatic tire as described above, the height H of the bead filler 6 from the bead heel 3a is from 10 to 30 mm. As a result, the content of the bead filler 6 is reduced and it is possible to reduce the weight of the tire. If the height H of the bead filler 6 is less than 10 mm, appearance flaws that occur during vulcanization can easily occur, which is a problem from the point of view of manufacture. If the height H of the bead filler 6 is greater than 30 mm, it is not possible to reduce the weight of the tire sufficiently, and the rolling resistance is reduced.

However, if the height H of the bead filler 6 is reduced in this way in order to reduce the weight of the tire, there is a problem that the tire circumferential rigidity is reduced so the steering stability is reduced. Therefore, the inner liner layer 9 that is disposed inward of the carcass layer 4 is formed from a thermoplastic resin or a thermoplastic elastomer compound that is blended from a thermoplastic resin component and an elastomer component having a Young's modulus of from 70 to 1500 MPa and a thickness of from 0.05 to 0.25 mm. Because this inner liner layer 9 is lightweight, it is possible to increase the tire circumferential rigidity and maintain a high level of steering stability without increasing the tire weight.

Here, if the Young's modulus of the inner liner layer 9 is less than 70 MPa, it is not possible to maintain a high level of steering stability. If the Young's modulus of the inner liner layer 9 is greater than 1500 MPa, the adhesive strength is insufficient so the durability is reduced. The Young's modulus of the inner liner layer 9 is preferably from 100 to 1300 MPa, and more preferably from 200 to 300 MPa.

Also, if the thickness of the inner liner layer 9 is less than 0.05 mm, it is not possible to obtain sufficient air permeability prevention. If the thickness of the inner liner layer 9 is greater than 0.25 mm, the rigidity in the tire radial direction becomes too large, so the riding comfort is reduced. The thickness of the inner liner layer 9 is preferably from 0.10 to 0.20 mm.

In the pneumatic tire as described above, an end 9a of the inner liner layer 9 is disposed farther inward in the tire radial direction than an end 6a outward in the tire radial direction of the bead filler 6. By overlapping the inner liner layer 9 and the bead filler 6 in this way, it is possible to reduce the variation in rigidity at the end 6a outward in the tire radial direction of the bead filler 6, and enhance the steering stability.

In this case, preferably, the end 9a of the inner liner layer 9 is disposed at a position separated from the end 6a outward in the tire radial direction of the bead filler 6 by from 5 to 20 mm inward in the tire radial direction. In other words, preferably, the amount of overlap in the tire radial direction between the inner liner layer 9 and the bead filler 6 is from 5 to 20 mm. Here, if the amount of overlap between the inner liner layer 9 and the bead filler 6 is less than 5 mm, the inner liner layer 9 can easily peel and the tire durability is reduced. If the amount of overlap between the inner liner layer 9 and the bead filler 6 is greater than 20 mm, the amount of variation in manufacture increases, so the position of the end of the inner liner layer 9 is not stable, and wrinkles and blisters can easily occur during vulcanization.

In the present technology, the carcass layer 4 has a single-layer structure, and a turned-up edge 4a of the carcass layer 4 is disposed farther inward in the tire radial direction than the maximum tire width position P and farther outward in the tire radial direction than the end 6a outward in the tire radial direction of the bead filler 6. By making the carcass layer 4 a single-layer structure, it is possible to reduce the weight of the tire. In addition, by disposing the turned-up edge 4a of the carcass layer 4 at the position as described above, it is possible to achieve both reduction in weight and steering stability of the tire to a high degree. If the turned-up edge 4a of the carcass layer 4 is disposed farther outward than the maximum tire width position P, it is not possible to reduce the weight of the tire sufficiently. In particular, preferably, the turned-up edge 4a of the carcass layer 4 is separated from the maximum tire width position P by not less than 10 mm inward in the tire radial direction, and separated from the end 6a outward in the tire radial direction of the bead filler 6 by not less than 10 mm outward in the tire radial direction. If the separation distance of the turned-up edge 4a of the carcass layer 4 from the maximum tire width position P is less than 10 mm, the content of the carcass layer 4 increases and it is not possible to achieve sufficient weight reduction of the tire. If the separation distance of the turned-up edge 4a of the carcass layer 4 from the end 6a outward in the tire width direction of the bead filler 6 is less than 10 mm, the tire durability is reduced.

In the present technology, preferably, the cross-sectional area in a meridian cross-section of the bead filler 6 is from 20 to 90 mm². By limiting the cross-sectional area of the bead filler 6 to be less than that of a conventional tire in this manner, the content of the bead filler 6 is reduced and it is possible to reduce the weight of the tire. If the cross-sectional area of the bead filler 6 is less than 20 mm², appearance flaws can easily occur during vulcanization. If the cross-sectional area of the bead filler 6 is greater than 90 mm², the bead filler 6 is too large, so it is not possible to sufficiently reduce the weight of the tire and the rolling resistance is reduced.

In the present technology, the cross-sectional shape of the bead filler 6 tapers to a point at the end 6a outward in the tire radial direction. By making the cross-sectional shape taper to a point in this manner, it is possible to reduce the content of the bead filler 6 and reduce the weight of the tire. There is no particular limitation on the shape provided the shape tapers to a point, preferably, the thickness in the tire width direction at the end 6a outward in the tire radial direction is from 0.3 to 2.0 mm, and preferably, the thickness in the tire width direction on the bead core 5 side is from 4.5 to 10.0 mm. If the thickness at the end 6a outward in the tire radial direction of the bead filler 6 is less than 0.3 mm, the end 6a outward in the tire radial direction of the bead filler 6 becomes too narrow, so the durability is reduced. If the thickness of the end 6a outward in the tire radial direction of the bead filler 6 is greater than 2.0 mm, the content of the bead filler 6 is increased, so it is not possible to reduce the weight of the tire sufficiently. If the thickness on the bead core 5 side of the bead filler 6 is less than 4.5 mm, appearance flaws can easily occur during vulcanization. If the thickness on the bead core 5 side of the bead filler 6 is greater than 10.0 mm, the content of the bead filler 6 increases, so it is not possible to reduce the weight of the tire sufficiently.

In the present technology, preferably, the hardness of the bead filler 6 is from 80 to 95. If the hardness of the bead filler 6 is less than 80, the steering stability is reduced. If the hardness of the bead filler 6 is greater than 95, the riding comfort is reduced. The hardness of the bead filler 6 is the hardness measured using a type A durometer at 20° C. in accordance with the durometer hardness test specified by JIS K6253.

In the present technology, preferably, the average rubber thickness of the side rubber layer that forms the side wall portion 2 is from 2.0 to 3.5 mm. If the average rubber thickness of the side wall portion 2 is less than 2.0 mm, the side cut resistance is insufficient, so the durability of the tire is reduced. If the average rubber thickness of the side wall portion 2 is greater than 3.5 mm, it is not possible to reduce the weight of the tire sufficiently.

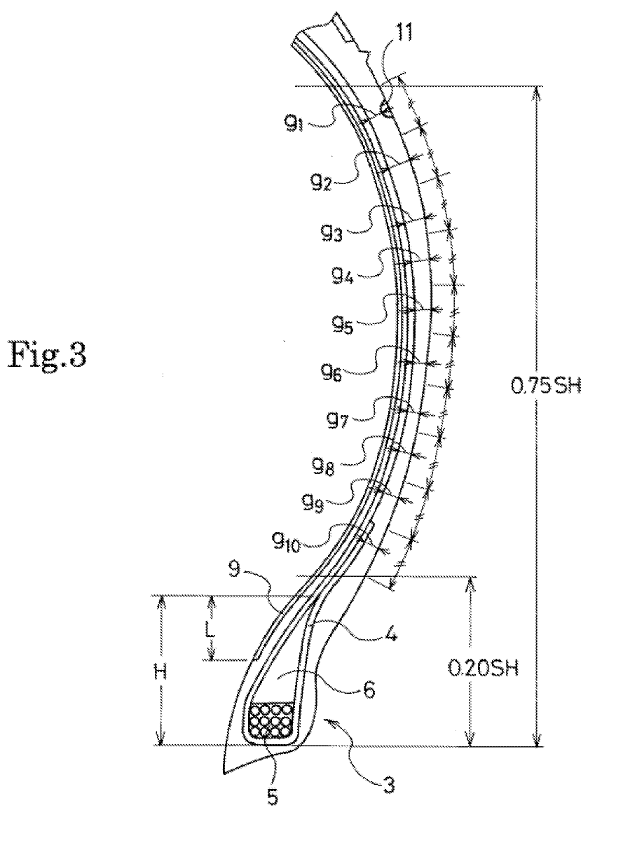

In the present technology, the average rubber thickness of the side rubber layer that forms the side wall portion 2 is the average rubber thickness over the range of height from 20% to 75% of the tire cross-section height SH, and it is obtained as follows. As illustrated in FIG. 3, the surface of the side wall portion 2 is divided into 10 equal portions along the radial direction, and the minimum values g₁ to g₁₀ of the rubber thickness in each portion is measured. At this time, if a recess 11 such as a dimple or the like is formed in the surface of the side wall portion 2, the minimum value of the rubber thickness including the recess 11 in each portion is measured (see g₁ in FIG. 3). The average value G of the measurement values g₁ to g₁₀ measured in this way is obtained. In addition, this average value G is obtained at any 4 positions on the periphery of the tire, and the average value of the average values G₁ to G₄ at these four positions is taken to be the average rubber thickness of the side rubber layer that forms the side wall portion 2. Also, the tire cross-section height SH is equal to the value of half the difference between the tire external diameter and the rim diameter, measured in accordance with the JATMA Yearbook.

In the present technology, there is no particular limitation on the structure of the bead core 5, but preferably, a single bead wire 5a is wound a plurality of times in an annular shape to form a single wound structure, and the spacing between loops of the bead wire 5a in a meridian cross-section of the bead core 5 is not more than 0.3 mm. In this way, it is possible to increase the bending rigidity of the bead portion 3 even though the bead filler 6 is reduced, so it is possible to enhance the steering stability. The spacing between loops of the bead wire 5a should be not more than 0.3 mm, but it does not matter if there is partial contact on the tire circumference. If the spacing between loops of the bead wire 5a is greater than 0.3 mm, the effect of improving the steering stability is insufficient.

More preferably, steel wire having a diameter of from 1.2 to 1.4 mm is used as the bead core 5, and from four to six loops are arranged in the tire width direction, and from 3 to 5 layers are stacked in the tire radial direction. As a result, it is possible to reduce the weight of the tire while maintaining the tire durability and the steering stability to a high degree. If the diameter of the steel wire is less than 1.2 mm, the effect of improving the steering stability is insufficient. If the diameter of the steel wire is greater than 1.4 mm, the effect of reduction in weight is insufficient.

In the present technology, preferably, the reinforcing layer 10 formed from a composite material of steel cords or organic fiber cords and rubber is provided outward in the tire width direction of the bead filler 6 and inward in the tire width direction of the carcass layer 4, as illustrated in FIG. 2. By providing such a reinforcing layer 10, the tire circumferential rigidity is increased and it is possible to enhance the steering stability. When the reinforcing layer 10 is provided, the weight of the tire is increased slightly, but it is possible to reduce the weight of the tire sufficiently relative to a conventional tire that has a large size bead filler.

Here, the height h of the end 10a outward in the tire radial direction of the reinforcing layer 10 from the bead heel is preferably from 20 to 35 mm. If the height h of the reinforcing layer 10 is less than 20 mm, it is not possible to enhance the steering stability sufficiently. If the height h of the reinforcing layer 10 is greater than 35 mm, the rolling resistance deteriorates. Here, aramid fiber cords, nylon cords, rayon cords, or the like are preferably used as the organic fiber cords that form the reinforcing layer.

Also, preferably, the reinforcing cord of the reinforcing layer 10 is inclined at 10° to 30° relative to the tire radial direction. If the inclination angle of the reinforcing cord is less than 10°, it will be difficult to manufacture the tire. If the inclination angle of the reinforcing cord exceeds 30°, it will not be possible to enhance the steering stability sufficiently.

In the present technology, tan δ at 60° C. of the rubber portion including maximum tire width position of the side rubber layer that forms the side wall portion 2 is preferably in the range from 0.02 to 0.10. By making tan δ at 60° C. of the side rubber layer not more than 0.10 in this way, it is possible to reduce the rolling resistance and suppress the heat build-up in the side wall portion 2. If tan δ is greater than 0.10, it is not possible to obtain a sufficient effect of suppressing heat build-up of the side wall portion 2. If tan δ is less than 0.02, the tire durability deteriorates. Tans at 60° C. is the value measured in a 60° C. environment under the conditions of a frequency of 20 Hz, an initial distortion of 10%, and a dynamic distortion of ±2% using a viscoelastic spectrometer manufactured by Toyo Seiki Seisaku-sho, Ltd.

Also, tan δ at 60° C. of the side rubber layer can be adjusted as appropriate by the compounded amount of the carbon black and the rubber that constitutes the side rubber layer. For example, by compounding 75 parts by weight of natural rubber, 25 parts by weight of butadiene rubber, and 25 parts by weight of carbon black, a rubber composition with tan δ at 60° C. of 0.02 can be obtained. By compounding 45 parts by weight of natural rubber, 55 parts by weight of butadiene rubber, and 35 parts by weight of carbon black, a rubber composition with tan δ at 60° C. of 0.06 can be obtained. By compounding 35 parts by weight of natural rubber, 65 parts by weight of butadiene rubber, and 50 parts by weight of carbon black, a rubber composition with tan δ at 60° C. of 0.10 can be obtained. In this way, it is possible to determine the tan δ at 60° C. of the side rubber layer.

In the present technology, preferably, a tire cross-sectional width SW and a tire maximum belt width BW have a relationship such that 0.68≦BW/SW≦0.80. If BW/SW is less than 0.68, it is not possible to obtain the effect of improving the steering stability sufficiently. If BW/SW is greater than 0.80, the rolling resistance deteriorates.

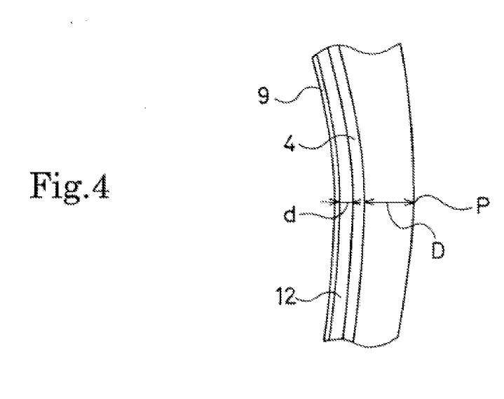

FIG. 4 illustrates an enlargement of a portion of the side wall portion 2 of the pneumatic tire according to the present technology. In the present technology, the rigidity of the inner liner layer 9 that is formed from a thermoplastic resin or thermoplastic elastomer composition is used to increase the steering stability, but in order to maximize the effect of increasing the rigidity based on the inner liner layer 9, preferably, the thickness of a tie rubber layer 12 that is interposed between the inner liner layer 9 and the carcass layer 4 is comparatively thick.

More specifically, as illustrated in FIG. 4, preferably, a ratio d/D of a distance d between the inner liner layer 9 and the carcass layer 4 at a smallest thickness portion of the side wall portion 2 to a distance D from the carcass layer 4 to the tire outer periphery is from ⅕ to ⅓. By setting the ratio d/D within the above range, it is possible to sufficiently obtain the effect of improving the steering stability, even when the side wall portion is made thinner to reduce the weight of the tire. If d/D is less than ⅕, the effect of improving the steering stability is reduced. If d/D is greater than ⅓, the reduction in weight of the tire is insufficient. In the example in FIG. 4, the smallest thickness portion of the side wall portion 2 and the maximum tire width position P are the same.

In the present technology, examples of thermoplastic resins that may be preferably used for the inner liner layer 9 include polyamide resins (for example, nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MXD6), nylon 6T, nylon 6/6T copolymer, nylon 66/PP copolymer, and nylon 66/PPS copolymer) and N-alkoxyalkylates thereof (for example, methoxy methylate of nylon 6, methoxy methylate of nylon 6/610 copolymer, and methoxy methylate of nylon 612), polyester resins (for example, aromatic polyesters such as polybutylene terephthalate (PBT), polyethylene terephthalate (PET), polyethylene isophthalate (PEI), PET/PEI copolymer, polyarylate (PAR), polybutylene naphthalate (PBN), liquid crystal polyester, and polyoxyalkylene diimidic acid/polybutylene terephthalate copolymer), polynitrile resins (for example, polyacrylonitrile (PAN), polymethacrylonitrile, acrylonitrile/styrene copolymer (AS), (meth)acrylonitrile/styrene copolymer, and (meth)acrylonitrile/styrene/butadiene copolymer), polymethacrylate resins (for example, polymethylmethacrylate (PMMA) and polyethylmethacrylate), polyvinyl resins (for example, polyvinyl acetate, polyvinyl alcohol (PVA), vinyl alcohol/ethylene copolymer (EVOH), polyvinylidene chloride (PVDC), polyvinyl chloride (PVC), vinyl chloride/vinylidene chloride copolymer, vinylidene chloride/methylacrylate copolymer, and vinylidene chloride/acrylonitrile copolymer), cellulose resins (for example, cellulose acetate and cellulose acetate butyrate), fluorine resins (for example, polyvinylidene fluoride (PVDF), polyvinyl fluoride (PVF), polychlorofluoroethylene (PCTFE), and tetrafluoroethylene/ethylene copolymer), imide resins (for example, aromatic polyimide (PI)); and the like. Also, in the present technology, the thermoplastic elastomer composition of the inner liner layer 9 can be formed from the above thermoplastic resins blended with an elastomer.

Examples of elastomers that may be preferably used in the thermoplastic elastomer composition include diene rubbers and hydrogenates thereof (for example, natural rubber (NR), isoprene rubber (IR), epoxidized natural rubber, styrene butadiene rubber (SBR), butadiene rubber (BR, high-cis BR and low-cis BR), nitrile butadiene rubber (NBR), hydrogenated NBR, and hydrogenated SBR), olefin rubbers (for example, ethylene propylene rubber (EPDM, EPM), maleated ethylene propylene rubber (M-EPM), butyl rubber (IIR), isobutylene and aromatic vinyl or diene monomer copolymer, acrylic rubber (ACM), and ionomer), halogen-containing rubbers (for example, Br-IIR, Cl-IIR, brominated copolymer of isobutylene/para-methyl styrene (Br-IPMS), chloroprene rubber (CR), chlorohydrin rubber (CHR), chlorosulfonated polyethylene rubber (CSM), chlorinated polyethylene rubber (CM), and maleated chlorinated polyethylene rubber (M-CM)), silicone rubbers (for example, methyl vinyl silicone rubber, di-methyl silicone rubber, and methyl phenyl vinyl silicone rubber), sulfur-containing rubbers (for example, polysulfide rubber), fluororubbers (for example, vinylidene fluoride rubbers, fluorine-containing vinyl ether rubbers, tetrafluoroethylene-propylene rubbers, fluorine-containing silicone rubbers, and fluorine-containing phosphazene rubbers), thermoplastic elastomers (for example, styrene elastomers, olefin elastomers, ester elastomers, urethane elastomers, and polyamide elastomers), and the like.

In the thermoplastic elastomer composition, the composition ratio of a particular thermoplastic resin to a particular elastomer is not particularly limited, and may be appropriately set so as to have a structure in which the elastomer is dispersed as a discontinuous phase in a matrix of the thermoplastic resin. However, the preferable range is from 10/90 to 90/10, and more preferably from 20/80 to 85/15 in weight ratio. By forming the thermoplastic elastomer composition with the thermoplastic resin as the continuous phase (matrix), and the elastomer as the dispersed phase (domain), the inner liner can be given both sufficient flexibility and rigidity, and it is possible to obtain the same processability as thermoplastic resin when forming, regardless of the quantity of elastomer.

If a particular thermoplastic resin among those described above is incompatible with such an elastomer, a compatibility agent may be used as a third component appropriately to make the two compatible with each other. The compatibility agent can be a copolymer having a structure of one or both of the thermoplastic resin and the elastomer, or also a copolymer structure having an epoxy group, carbonyl group, halogen group, amino group, oxazoline group, hydroxy group, or the like that is capable of reacting with the thermoplastic resin or the elastomer. These may be selected depending on the types of thermoplastic resin and elastomer to be blended. The compounded amount of the compatibility agent is not particularly limited, but preferably is from 0.5 to 10 parts by weight per 100 parts by weight of the polymer component (the sum of the thermoplastic resin and the elastomer).

In the present technology, fillers (calcium carbonate, titanium oxide, alumina, and the like) that are generally blended in polymer compositions, carbon black, reinforcing agents such as white carbon or the like, softeners, plasticizers, processing aids, pigments, dyes, antiaging agents, and the like can be added as desired to the thermoplastic resin or the thermoplastic elastomer composition, provided properties that are necessary for the inner liner do not deteriorate.

### EXAMPLES

Twenty one types of tire were produced: Conventional Example 1, Comparative Example 1, and Working Examples 1 to 19. The tire size was 195/65R15 which was common for all the tires. The Young's modulus of the inner liner layer, the thickness of the inner liner layer, the height H of the bead filler from the bead heel, the cross-sectional area of the bead filler, the shape of the bead filler, the separation distance of the carcass end from the maximum tire width position, the separation distance of the carcass end from the bead filler end, the amount of overlap between the inner liner layer and the bead filler, the average rubber thickness of the side wall portion, the wire spacing of the bead core, whether or not there was a reinforcing layer between the bead filler and the carcass layer, tan δ of the rubber of the side wall portion, and the ratio BW/SW of the tire maximum belt width BW to the tire cross-sectional width SW are shown in Tables 1 to 4.

The separation distance of the carcass end from the maximum tire width position was indicated as positive for separation distances inward in the tire radial direction, and negative for separation distances outward in the tire radial direction. Specifically, the carcass end of Conventional Example 1 was folded back farther outward in the tire radial direction than the maximum tire width position, so the separation distance of the carcass end from the maximum tire width position was negative.

The steering stability, rolling resistance, and tire weight were evaluated according to the methods described below and results were recorded in Tables 1 to 4 for each of the 21 types of test tires.

### Steering Stability

The test tires were fitted to a wheel with rim size of 15x6J, the front tires were inflated to an air pressure of 230 kPa, the rear tires were inflated to an air pressure of 220 kPa, and the wheels were fitted to a Japanese-made hybrid vehicle with engine displacement of 1.8 liters. A steering stability feeling evaluation was performed by five test drivers when traveling on a test course, and their average value was obtained. The evaluation results were expressed as index values, Conventional Example 1 being assigned an index value of 100. Larger index values indicate superior steering stability.

### Rolling Resistance

Using a drum test machine with a drum diameter of 1707.6 mm, the rolling resistance of the test tires was measured in accordance with ISO 28580, under the conditions of air pressure of 210 kPa, load of 4.82 kN, and speed of 80 km/h. The evaluation results were expressed using the multiplicative inverse, indexed with the Conventional Example 1 being 100. Larger index values indicate less rolling resistance.

### Tire Weight

The weight of the test tires was measured. The evaluation results were expressed using the multiplicative inverse, indexed with the Conventional Example 1 being 100. Larger index values indicate less tire weight.

TABLE 1

| | | | | Working | Working | Working | Working |
|---|---|---|---|---|---|---|---|
| | | Conventional | Comparative | Example | Example | Example | Example |
| | | Example 1 | Example 1 | 1 | 2 | 3 | 4 |
| Young's modulus | MPa | 20 | 50 | 250 | 70 | 1500 | 250 |
| of inner liner | | | | | | | |
| layer | | | | | | | |
| Thickness of | mm | 0.20 | 0.13 | 0.13 | 0.13 | 0.13 | 0.05 |
| inner liner layer | | | | | | | |
| Height of bead | mm | 40 | 15 | 15 | 15 | 15 | 15 |
| filler | | | | | | | |
| Cross-sectional | mm² | 130 | 60 | 60 | 60 | 60 | 60 |
| area of bead filler | | | | | | | |
| Shape of bead | | Tapering to a | Tapering to a | Tapering | Tapering | Tapering | Tapering |
| filler | | point | point | to a | to a | to a | to a |
| | | | | point | point | point | point |
| Separation | mm | −5 | 15 | 15 | 15 | 15 | 15 |
| distance of | | | | | | | |
| carcass end from | | | | | | | |
| maximum tire | | | | | | | |
| width position | | | | | | | |
| Separation | mm | 15 | 20 | 20 | 20 | 20 | 20 |
| distance of | | | | | | | |
| carcass end from | | | | | | | |
| bead filler end | | | | | | | |
| Amount of | mm | 40 | 10 | 10 | 10 | 10 | 10 |
| overlap between | | | | | | | |
| inner liner layer | | | | | | | |
| and bead filler | | | | | | | |
| Average rubber | mm | 4.0 | 3.0 | 3.0 | 3.0 | 3.0 | 3.0 |
| thickness of side | | | | | | | |
| wall portion | | | | | | | |
| Wire spacing of | mm | 0.2 | 0.2 | 0.2 | 0.2 | 0.2 | 0.2 |
| bead core | | | | | | | |
| Reinforcing layer | | Absent | Absent | Absent | Absent | Absent | Absent |
| between bead | | | | | | | |
| filler and carcass | | | | | | | |
| layer | | | | | | | |
| Tanδ of side wall | | 0.06 | 0.06 | 0.06 | 0.06 | 0.06 | 0.06 |
| portion rubber | | | | | | | |
| BW/SM | | 0.87 | 0.75 | 0.75 | 0.75 | 0.75 | 0.75 |
| Steering stability | Index | 100 | 95 | 105 | 100 | 110 | 100 |
| | value | | | | | | |
| Rolling | Index | 100.0 | 106.0 | 105.0 | 106.0 | 102.0 | 105.2 |
| resistance | value | | | | | | |
| Tire Weight | Index | 100.0 | 105.0 | 105.0 | 105.0 | 105.0 | 105.1 |
| | value | | | | | | |

TABLE 2

| | | Working | Working | Working | Working | Working |
|---|---|---|---|---|---|---|
| | | Example | Example | Example | Example | Example |
| | | 5 | 6 | 7 | 8 | 9 |
| Young's modulus of inner | MPa | 250 | 250 | 250 | 250 | 250 |
| liner layer | | | | | | |
| Thickness of inner liner | mm | 0.25 | 0.13 | 0.13 | 0.13 | 0.13 |
| layer | | | | | | |
| Height of bead filler | mm | 15 | 10 | 25 | 15 | 15 |
| Cross-sectional area of | mm² | 60 | 40 | 90 | 60 | 60 |
| bead filler | | | | | | |
| Shape of bead filler | | Tapering | Tapering | Tapering | Tapering | Tapering |
| | | to a | to a | to a | to a | to a |
| | | point | point | point | point | point |
| Separation distance of | mm | 15 | 15 | 15 | 15 | 15 |
| carcass end from | | | | | | |
| maximum tire width | | | | | | |
| position | | | | | | |
| Separation distance of | mm | 20 | 25 | 10 | 20 | 20 |
| carcass end from bead | | | | | | |
| filler end | | | | | | |
| Amount of overlap | mm | 10 | 10 | 10 | 10 | 10 |
| between inner liner layer | | | | | | |
| and bead filler | | | | | | |
| Average rubber thickness | mm | 3.0 | 3.0 | 3.0 | 2.0 | 3.5 |
| of side wall portion | | | | | | |
| Wire spacing of bead core | mm | 0.2 | 0.2 | 0.2 | 0.2 | 0.2 |
| Reinforcing layer between | | Absent | Absent | Absent | Absent | Absent |
| bead filler and carcass | | | | | | |
| layer | | | | | | |
| Tanδ of side wall portion | | 0.06 | 0.06 | 0.06 | 0.06 | 0.06 |
| rubber | | | | | | |
| BW/SM | | 0.75 | 0.75 | 0.75 | 0.75 | 0.75 |
| Steering stability | Index | 106 | 100 | 110 | 105 | 106 |
| | value | | | | | |
| Rolling resistance | Index | 104.8 | 107.0 | 103.0 | 105.1 | 105.0 |
| | value | | | | | |
| Tire Weight | Index | 104.9 | 105.5 | 104.0 | 105.4 | 104.6 |
| | value | | | | | |

TABLE 3

| | | Working | Working | Working | Working | Working |
|---|---|---|---|---|---|---|
| | | Example | Example | Example | Example | Example |
| | | 10 | 11 | 12 | 13 | 14 |
| Young's modulus of inner | MPa | 250 | 250 | 250 | 250 | 250 |
| liner layer | | | | | | |
| Thickness of inner liner | mm | 0.13 | 0.13 | 0.13 | 0.13 | 0.13 |
| layer | | | | | | |
| Height of bead filler | mm | 15 | 15 | 15 | 15 | 15 |
| Cross-sectional area of | mm² | 60 | 60 | 60 | 60 | 60 |
| bead filler | | | | | | |
| Shape of bead filler | | Tapering | Tapering | Tapering | Tapering | Tapering |
| | | to a | to a | to a | to a | to a |
| | | point | point | point | point | point |
| Separation distance of | mm | 10 | 25 | 15 | 15 | 15 |
| carcass end from | | | | | | |
| maximum tire width | | | | | | |
| position | | | | | | |
| Separation distance of | mm | 25 | 10 | 20 | 20 | 20 |
| carcass end from bead | | | | | | |
| filler end | | | | | | |
| Amount of overlap | mm | 10 | 10 | 5 | 20 | 10 |
| between inner liner layer | | | | | | |
| and bead filler | | | | | | |
| Average rubber thickness | mm | 3.0 | 3.0 | 3.0 | 3.0 | 3.0 |
| of side wall portion | | | | | | |
| Wire spacing of bead core | mm | 0.2 | 0.2 | 0.2 | 0.3 | 0.2 |
| Reinforcing layer between | | Absent | Absent | Absent | Absent | Absent |
| bead filler and carcass | | | | | | |
| layer | | | | | | |
| Tanδ of side wall portion | | 0.06 | 0.06 | 0.06 | 0.06 | 0.06 |
| rubber | | | | | | |
| BW/SM | | 0.75 | 0.75 | 0.75 | 0.75 | 0.75 |
| Steering stability | Index | 105 | 105 | 105 | 105 | 104 |
| | value | | | | | |
| Rolling resistance | Index | 105.0 | 105.0 | 105.0 | 105.0 | 105.0 |
| | value | | | | | |
| Tire Weight | Index | 104.8 | 105.3 | 105.1 | 104.9 | 104.9 |
| | value | | | | | |

TABLE 4

| | | Working | Working | Working | Working | Working |
|---|---|---|---|---|---|---|
| | | Example | Example | Example | Example | Example |
| | | 15 | 16 | 17 | 18 | 19 |
| Young's modulus of inner | MPa | 250 | 250 | 250 | 250 | 250 |
| liner layer | | | | | | |
| Thickness of inner liner | mm | 0.13 | 0.13 | 0.13 | 0.13 | 0.13 |
| layer | | | | | | |
| Height of bead filler | mm | 15 | 15 | 15 | 15 | 15 |
| Cross-sectional area of | mm² | 60 | 60 | 60 | 60 | 60 |
| bead filler | | | | | | |
| Shape of bead filler | | Tapering | Tapering | Tapering | Tapering | Tapering |
| | | to a | to a | to a | to a | to a |
| | | point | point | point | point | point |
| Separation distance of | mm | 15 | 15 | 15 | 15 | 15 |
| carcass end from | | | | | | |
| maximum tire width | | | | | | |
| position | | | | | | |
| Separation distance of | mm | 20 | 20 | 20 | 20 | 20 |
| carcass end from bead | | | | | | |
| filler end | | | | | | |
| Amount of overlap | mm | 10 | 10 | 10 | 10 | 10 |
| between inner liner layer | | | | | | |
| and bead filler | | | | | | |
| Average rubber thickness | mm | 3.0 | 3.0 | 3.0 | 3.0 | 3.0 |
| of side wall portion | | | | | | |
| Wire spacing of bead core | mm | 0.2 | 0.2 | 0.2 | 0.2 | 0.2 |
| Reinforcing layer between | | Present | Absent | Absent | Absent | Absent |
| bead filler and carcass | | | | | | |
| layer | | | | | | |
| Tanδ of side wall portion | | 0.06 | 0.02 | 0.10 | 0.06 | 0.06 |
| rubber | | | | | | |
| BW/SM | | 0.75 | 0.75 | 0.75 | 0.71 | 0.85 |
| Steering stability | Index | 107 | 105 | 105 | 104 | 105 |
| | value | | | | | |
| Rolling resistance | Index | 105.0 | 106.0 | 103.0 | 105.0 | 103.0 |
| | value | | | | | |
| Tire Weight | Index | 101.5 | 105.0 | 105.0 | 105.8 | 104.0 |
| | value | | | | | |

As can be seen from Tables 1 to 4, with each of Working Examples 1 to 19, it was possible to reduce the rolling resistance and the tire weight while maintaining the steering stability compared with Conventional Example 1.

On the other hand, with Comparative Example 1 in which Young's modulus of the inner liner layer was low, although the rolling resistance and tire weight were reduced, the steering stability deteriorated.

1. A pneumatic tire comprising a carcass layer mounted between a pair of bead portions, the carcass layer being folded back around a bead core embedded in each of the bead portions, a bead filler disposed on the bead core, and an inner liner layer disposed inward of the carcass layer, wherein
a height H of the bead filler from a bead heel is from 10 to 30 mm; the inner liner layer is formed from a thermoplastic resin or a thermoplastic elastomer composition that is blended from a thermoplastic resin component and an elastomer component having a Young's modulus of from 70 to 1500 MPa and a thickness of from 0.05 to 0.25 mm; and an end of the inner liner layer is disposed farther inward in a tire radial direction than an end outward in the tire radial direction of the bead filler.

2. The pneumatic tire according to claim 1, wherein: the carcass layer has a single-layer structure, and a turned-up edge of the carcass layer is disposed farther inward in the tire radial direction than a maximum tire width position and farther outward in the tire radial direction than the end outward in the tire radial direction of the bead filler.

3. The pneumatic tire according to claim 2, wherein: the turned-up edge of the carcass layer is separated from the maximum tire width position by not less than 10 mm inward in the tire radial direction, and separated from the end outward in the tire radial direction of the bead filler by not less than 10 mm outward in the tire radial direction.

4. The pneumatic tire according to claim 1, wherein: a cross-sectional area in a meridian cross-section of the bead filler is from 20 to 90 mm², and a shape of the bead filler tapers to a point at the end outward in the tire radial direction of the bead filler.

5. The pneumatic tire according to claim 1, wherein: an end of the inner liner layer is disposed at a position separated from an end outward in the tire radial direction of the bead filler by from 5 to 20 mm inward in the tire radial direction.

6. The pneumatic tire according to claim 1, wherein an average rubber thickness of a side rubber layer forming a side wall portion is from 2.0 to 3.5 mm.

7. The pneumatic tire according to claim 1, wherein: the bead core has a single wire bead core structure in which a single bead wire is wound around the bead core a plurality of times in an annular shape, and a spacing between the loops of the bead wire in a meridian cross-section of the bead core is not more than 0.3 mm.

8. The pneumatic tire according to claim 1, wherein: a reinforcing layer formed from a composite material of steel cords or organic fiber cords and rubber is provided outward in a tire width direction of the bead filler and inward in the tire width direction of the carcass layer.

9. The pneumatic tire according to claim 1, wherein tan δ at 60° C. of a rubber portion including the maximum tire width position of the side rubber layer forming the side wall portion is in a range from 0.02 to 0.10.

10. The pneumatic tire according to claim 1, wherein a relationship between a tire cross-sectional width SW and a tire maximum belt width BW is such that 0.68≦BW/SW≦0.80.

11. The pneumatic tire according to claim 2, wherein: a cross-sectional area in a meridian cross-section of the bead filler is from 20 to 90 mm², and a shape of the bead filler tapers to a point at the end outward in the tire radial direction of the bead filler.

12. The pneumatic tire according to claim 11, wherein: an end of the inner liner layer is disposed at a position separated from an end outward in the tire radial direction of the bead filler by from 5 to 20 mm inward in the tire radial direction.

13. The pneumatic tire according to claim 12, wherein an average rubber thickness of a side rubber layer forming a side wall portion is from 2.0 to 3.5 mm.

14. The pneumatic tire according to claim 13, wherein: the bead core has a single wire bead core structure in which a single bead wire is wound around the bead core a plurality of times in an annular shape, and a spacing between the loops of the bead wire in a meridian cross-section of the bead core is not more than 0.3 mm.

15. The pneumatic tire according to claim 14, wherein: a reinforcing layer formed from a composite material of steel cords or organic fiber cords and rubber is provided outward in a tire width direction of the bead filler and inward in the tire width direction of the carcass layer.

16. The pneumatic tire according to claim 15, wherein tan δ at 60° C. of a rubber portion including the maximum tire width position of the side rubber layer forming the side wall portion is in a range from 0.02 to 0.10.

17. The pneumatic tire according to claim 16, wherein a relationship between a tire cross-sectional width SW and a tire maximum belt width BW is such that 0.68≦BW/SW≦0.80.
